(19) United States
(12) Patent Application Publication
(10) Pub. No.: US 2024/0336851 A1
(43) Pub. Date: Oct. 10, 2024

(54) HYDROTREATMENT UPFLOW REACTORS WITH HIGH HYDROGEN-HYDROCARBON LIQUID CONTACT SURFACE AND IMPROVED HYDRO-GENATION CAPACITY

(71) Applicant: Luigi PATRON, Milano (MI) (IT)

(72) Inventor: Luigi PATRON, Milano (MI) (IT)

(21) Appl. No.: 18/252,514

(22) PCT Filed: Nov. 7, 2022
(86) PCT No.: PCT/IT2022/050288

§ 371 Date: May 10, 2023

(30) Foreign Application Priority Data
Aug. 2, 2022 (IT) 102022000016413

(51) Int. Cl. C10G 47/26; B01D 3/10; B01J 8/22

(52) U.S. Cl. CPC C10G 47/26; B01D 3/101; B01J 8/22; C10G 2300/1074

(57) ABSTRACT

Disclosed is a process in which the jump in hydrogenation capacity, necessary to hydroconvert heavy oils totally to light hydrocarbons (350° C.−), is obtained by using an upflow reactor equipped with a gas distributor having a high density of orifices, which is capable of causing the packing of the gas bubbles, this being the most advantageous fluid dynamic condition. The resulting conversion products are suitable as petrochemical feedstocks.

### FIELD OF APPLICATION OF THE INVENTION

The high hydrogenation capacity upflow reactor object of the present invention can be used in the hydroconversion of heavy oils, including crude oils, and in the hydrotreatment of vacuum distillates.

### REVIEW OF THE PRIOR ART

The hydroconversion of heavy oils by means of technologies that use ebullated catalytic bed (supported catalysts) reactors is notoriously only partial, since some unconverted residue remains alongside light distillates (350° C.−) and heavy distillates (350° C.+).

A different technology, using slurry type catalysts (slurry technology), which has had recent and multiple confirmations on a commercial scale, allows instead a complete chemical conversion.

The slurry technology, due to the completeness of the chemical conversion and the fact that it operates according to a closed liquid circuit, would be suitable for bringing the conversion of heavy oils, and crude oils, totally to light hydrocarbons (350° C.−), a goal never achieved until now. This is on condition of having a slurry bubble column reactor with the required hydrogenation capacity that the current upflow reactors have not yet reached.

In upflow reactors, used in hydroconversion of heavy oils, hydrogen is fed simply by bubbling.

Such reactors when used: a) in the hydroconversion of heavy oils by means of slurry catalysts; b) in the hydroconversion of heavy oils by supported catalysts, show a limited hydrogenation capacity due to a low gas-liquid contact surface that the hydrogen, fed without specific precautions, generates. The problem of the limited hydrogenation capacity of the upflow reactors is dealt with in U.S. Pat. No. 11,241,673. The solution described therein, however, does not allow to raise the hydrogen content in the conversion products, which instead is required to bring the hydroconversion of heavy oils totally to light hydrocarbons (350° C.−).

To raise the hydrogen content in the conversion products (product slate), it is necessary to increase the gas-liquid contact surface through which the hydrogen must diffuse in order to feed all the reactions that a hydroconversion process requires.

A first upflow reactor capable of increasing the gas-liquid contact surface has been described in the Italian Patent N. 102020000009880, corresponding to WO2021/224949 A1.

In a bubbling regime, the contact surface of the gas bubbles with the liquid, expressed in m2 per m3 of liquid, is called specific gas-liquid surface and is indicated by as. For purely geometric reasons, the specific surface as is directly proportional to the gas holdup eg and inversely proportional to the average diameter ds of the bubbles, resulting in as=6 eg/ds, where eg is expressed in fraction of unit and ds in meter. In the aforementioned Italian Patent N. 102020000009880, in order to obtain a higher specific gas-liquid surface, the usual flow of hydrogen fed to an upflow reactor is splitted into at least 64 and up to 2500 inputs per m2. This hydrogen splitting, decreasing the diameter of the bubbles ds and, at the same time, raising the gas holdup eg to values higher than 0.33, up to 0.5 and beyond, produces an increase in the specific gas-liquid surface as.

Raising the gas holdup, however, reduces the volume of reaction liquid in the reactor. This implies that, alongside an increase in hydrogenation capacity, a loss of cracking capacity (due to a lower quantity of liquid charge in the reactor) must be taken into account. A lower cracking capacity can be compensated through the catalyst when this is of the supported type, as it catalyzes molecular cracking in addition to hydrogenation, as in cases b) mentioned above, but not in case a) relating to a process of hydroconversion of heavy oils by means of slurry catalysts, since these unsupported catalysts have no effect on the cracking kinetics. The cracking rate, alternatively, can be increased by raising the temperature of the reactor, but this path is not feasible when the goal is to increase the hydrogenation capacity, since the hydrogenation kinetics decreases as the temperature increases.

In the case of hydroconversion of heavy oils with a slurry catalyst, the use of the reactor describe in the Italian Patent N. 102020000009880 implies that, in order not to burden the capacity of the system, the raising of the specific gas-liquid surface must remain limited. Limited to a level which is insufficient to increase the hydrogenation capacity as would be required to convert heavy oils totally to light hydrocarbons (350° C.−).

### OBJECT OF THE INVENTION

The object of the present invention is to overcome the aforementioned drawbacks by indicating, by using an upflow reactor, a hydrotreatment process capable of expanding the specific gas-liquid surface, without having to raise the gas holdup level, thus being able to increase the hydrogenation capacity without penalising the capacity of the system.

### SUMMARY OF THE INVENTION

The hydrogenation capacity of a slurry bubble column reactor, used in the hydroconversion of heavy oils and in the hydrotreatment of vacuum distillates, is increased, without having to raise the gas holdup, through the expansion of the gas-liquid unit surface by equipping the reactor with a gas distributor, having at least 100 orifices per m2, which is fed with hydrogen at a surface velocity such as to cause the packing of the gas bubbles, whatever density of orifices the gas distributor used has. That of the packing of the bubbles is the fluid dynamic condition which allows the highest liquid filling of the reactor while the gas-liquid unit surface is maximum.

The achievable increase in the hydrogenation capacity is such as to allow the hydroconversion of heavy oils totally to light hydrocarbons (350° C.−). The resulting set of conversion products can reach a weight average content of hydrogen which makes it particularly suitable as a petrochemical feedstock.

Other innovative features of the present invention are illustrated in the following description and recalled in the dependent claims.

### DESCRIPTION OF THE FIGURES

Further objects and advantages of the present invention will become clear from the following detailed description of examples of embodiment of the same and from the attached drawings in which:

FIG. 1 shows how, in a bubble column reactor, the gas holdup grows linearly with the surface velocity of the hydrogen, expressed as uG/uG\hat{ }, until the packing of the gas bubble is reached (uG\hat{ } is the surface velocity, cm/s, at which bubble packing is reached). The gas-liquid unit surface, given by the product aₛ×(1−eg), grows with the ratio uG/uG\hat{ } only until the packing of the gas bubbles is complete (see full dots);

FIG. 2 provides, as a function of the density of orifices of the gas distributor used, the upper limit of the surface velocity with which to feed the hydrogen to expand the specific gas-liquid surface while keeping the gas holdup value no more than the limit of 0.33;

FIG. 3 shows the process by which the light hydrocarbons (350° C.−) are removed faster from the reactor to prevent the separation of asphaltenes from the reaction liquid.

### DETAILED DESCRIPTION OF SOME PREFERRED EMBODIMENTS OF THE INVENTION

In the continuation of the present description a figure may also be illustrated with reference to elements not expressly indicated in that figure but in other figures. The scale and the proportions of the various elements depicted do not necessarily correspond to the real ones.

### Reactor Hydrogenation Capacity

The hydrogenation unit capacity of a bubble column reactor (t/h of reacted hydrogen per m3) determines the amount of hydrogen incorporated into the product slate. The hydrogenation unit capacity is proportional to the gas-liquid unit surface, expressed as m2 per m3 of reactor volume, given by as x (1−eg), in which (1−eg) is the fraction of reactor volume occupied by the reaction liquid, while as is the specific gas-liquid surface, seen above.

The hydrogenation unit capacity is maximum when the gas-liquid unit surface as x (1−eg) is.

### Gas-Liquid Unit Surface

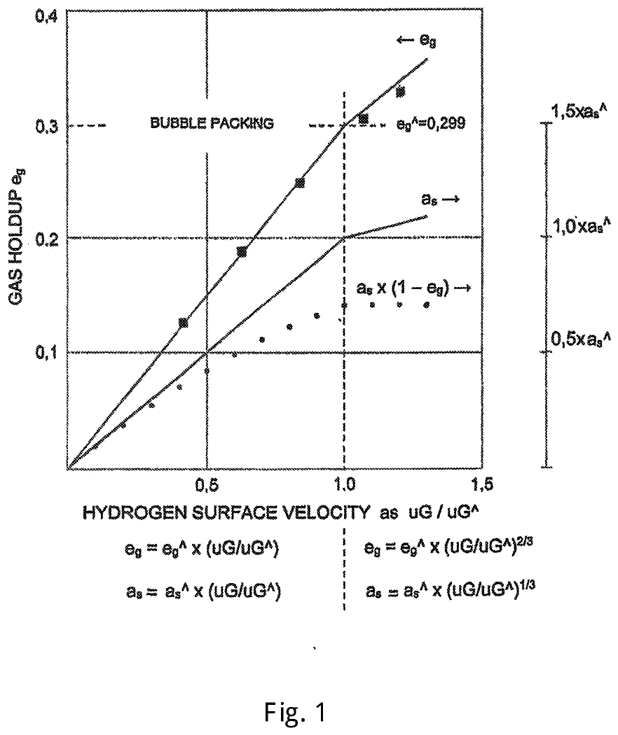

In a bubble column, starting to feed gas (hydrogen, for the purpose of this application) with a surface velocity uG, expressed as uG/uG\hat{ }, a linear growth of the gas holdup eg is observed, see FIG. 1, where uG\hat{ } is the surface velocity of the hydrogen (cm/s) at which bubble packing is reached. The rise speed of the bubbles (swarm velocity), which is given by the ratio uG/eg, is directly proportional to their diameter ds (Word Academy of Science, Engineering and Technology, Terminal velocity of a bubble rise in a liquid column, 28 2007 Talaia), therefore, it can be written uG/eg=kds. With a eg/uG ratio that remains constant, its inverse uG/eg also remain constant. This implies that ds, the diameter of the bubbles, remain constant during the linear growth of eg, at a value denoted by ds\hat{ }.

As the surface velocity (volumetric flow rate) of the gas (hydrogen) increases, the number Nb of bubbles present per unit volume of the reactor linearly increases. This causes the reactor gas holdup to rise linearly, according to eg=Nb×π/6×(ds\hat{ })3. The linear growth of eg with uG is followed by that of as, since as=6 eg/ds.

The linear growth of eg and as with the surface velocity of the gas (hydrogen) continues until the number of bubbles reaches the maximum value, Nb\hat{ }=eg\hat{ }/[π/6×(ds\hat{ })3], at which their packing is completed. For gas (hydrogen) surface velocity greater than uG\hat{ }, the bubbles begin to coalesce and their diameter to grow.

With uniform diameter of the bubbles, and for any bubble diameter, the geometric configuration of the packing of the bubbles is theoretically predicted at a gas holdup value of 0.296≃0.3 (International Journal of Chemical Reactor Engineering, A Review on Flow Regime Transition in Bubble Column, Vol. 5

, Review R1, 4.2.1.2 Mishima and Ishii). Since, as will be shown later, a value 0.299 is substantially confirmed experimentally, therefore with the natural distribution of the diameters of the bubbles, in FIG. 1 the gas holdup eg\hat{ } at which the packing of the bubbles is completed is set equal to 0.299.

The value assumed by the physical quantities Nb, uG, eg, as and ds when the packing of hydrogen bubbles has been completed, in this application is indicated with “\hat{ }”.

Once the bubble packing is achieved, continuing to increase the gas (hydrogen) surface velocity uG beyond uG\hat{ }, the diameter of the bubbles, which was previously constant, and equal to ds\hat{ }, begin to grow in the first approximation as ds\hat{ }×(uG/uG\hat{ })⅓. The growth of the diameter of the bubbles, which increases their rise speed, slows down the growth of eg which, from bubble packing onwards, will rise according to eg\hat{ }×(uG/uG\hat{ })⅔. Being the specific gas-liquid surface as always equal to 6 eg/ds, once the packing has been completed, as becomes equal to 6 eg\hat{ }×(uG/uG\hat{ })⅔/ds\hat{ }×(uG/uG\hat{ })⅓, that is equal to as\hat{ }×(uG/uG\hat{ })⅓.

It happens that while the specific gas-liquid surface as grows as as\hat{ }×(uG/uG\hat{ }) up to the packing of the bubbles, beyond it grows more slowly, as as\hat{ }×(uG/uG\hat{ })⅓.

The reduction in the growth of as combined with the continued reduction of (1−eg), causes the product as x (1−eg), once the packing of the bubbles has been reached, no longer grows, as indicated by full dots in FIG. 1. The gas-liquid unit surface as x (1−eg) reaches the maximum value when the packing of the bubbles has been completed at eg=eg\hat{ }=0.299, for uG=uG\hat{ }, then remains constant for a while before decreasing (not shown in FIG. 1).

The trend of the gas holdup eg, shown in FIG. 1, is expressed as a function of the surface velocity of gas (hydrogen) measured not in cm/s, as is usually done, but as a ratio with respect to gas (hydrogen) surface velocity uG\hat{ } at the packing of the bubbles. This has been done so that the trend described for eg can hold for any value of uG\hat{ }. So, although uG\hat{ } changes with the orifice density of the gas distributor used, as will be seen later, FIG. 1 remains valid whatever orifice density the gas distributor used has.

Moreover, given that uG\hat{ } also varies with the density of the liquid—the density determines the rise speed of the bubbles—the way of expressing the surface velocity of the gas as uG/uG\hat{ } ensures that FIG. 1 remains valid, at the same time, for the gas-liquid mixture of an ebullated catalytic bed reactor, with uG\hat{ } which, due to the high density of the reaction medium, is typically positioned between 4.5 and 5.5 cm/s, as well as for the gas-liquid mixture of a reactor that uses a slurry catalyst, which does not modify the density of the liquid, with uG\hat{ } typically limited to 2.5 cm/s.

Specifically, from FIG. 1 it can be seen that the gas-liquid unit surface as x (1−eg), on whose value the reactor hydrogenation capacity depends, once the as\hat{ }×(1−eg\hat{ }) value is reached, in correspondence with the packing of the bubbles, at a gas holdup 0.299 and at a surface velocity of hydrogen uG/uG\hat{ }=1, to a further increase of uG/uG\hat{ } stops growing, while the liquid filling of the reactor (1−eg) continues to drop. This means that a reactor operating with a surface velocity of hydrogen uG/uG\hat{ } close to 1, therefore with gas holdup close to 0.299, will have the highest possible liquid filling, while the gas-liquid unit surface is maximum. A surface velocity of the hydrogen uG/uG\hat{ } higher than 1 can be used to ensure a higher flow of hydrogen, for example to support the partial pressure of hydrogen and/or the evaporation of conversion products in the reactor. In this case, the increase in the surface velocity of the hydrogen will however be limited so as to contain the gas holdup to no more than 0.33 in order not to jeopardize the liquid filling of the reactor.

The maximum value reached by the gas-liquid unit surface, given by as\hat{ }×(1−eg\hat{ }), being eg\hat{ }=0.299, becomes 0.701 as\hat{ }. That is, the gas-liquid unit surface will be maximum when as\hat{ } is.

The specific gas-liquid surface as\hat{ } is, therefore, the physical quantity to be raised to increase the hydrogenation capacity, but with the gas holdup that does not exceed 0.33 and preferably is equal or close to 0.299 to operate with the highest liquid filling of the reactor.

Raising of the Specific Gas-Liquid Surface aₛ\hat{ }

As mentioned above, in a liquid-gas mixture, generated in a bubble column by a given gas distributor, the uG/eg ratio is directly proportional to the average diameter of the bubbles, i.e. uG/eg=kds, which at the packing of the bubbles becomes uG\hat{ }/eg\hat{ }=kds\hat{ }, that is uG\hat{ }=0.299 kds\hat{ }. Thus it results that the surface velocity of the gas (hydrogen) uG\hat{ } which completes the bubble packing is proportional to the diameter of the bubbles generated. The smaller uG\hat{ }, the smaller the diameter ds\hat{ } of the bubbles will be. Furthermore, the equality as=6 eg/ds, for bubble packing becomes as\hat{ }=1.794/ds\hat{ }. Using uG\hat{ }=0.299 kds\hat{ }, it finally becomes as\hat{ }=0.536 k/uG\hat{ }.

This means that, through the proportionality constant 0.536 k, the inverse of the surface velocity of the gas (hydrogen) at which the bubble packing is completed, that is 1/uG\hat{ }, is the measure of the specific gas-liquid surface as\hat{ } generated by that gas distributor. The lower the surface velocity uG\hat{ } of the gas (hydrogen) at which, using a given gas distributor, bubble packing is completed, the larger the specific gas-liquid surface generated by that gas distributor will be.

The surface velocity uG\hat{ } of the gas (hydrogen) at which, using a gas distributor having a given orifice density, the packing of the bubbles is completed, can be detected experimentally. As stated above, the value of uG\hat{ } is that of the surface velocity of gas (hydrogen) after which the growth of eg begin to slow down, deviating from the previous linear trend due to the onset of the coalescence phenomenon. This can be appreciated in FIG. 1 and, in more detail, in FIG. 5 of the aforementioned U.S. Pat. No. 5,308,476. According this last reference, the initial growth trend of eg, given by the first three black squares, deviates from linearity resulting in a slower growth trend that crosses said first trend when the surface velocity of hydrogen reaches 0.139 fps (=4.23 cm/s). To this value of the surface velocity of hydrogen, bubble packing is assumed to have been reached. Alternatively, and in a simpler way, the surface velocity of hydrogen at which the packing of the bubbles is complete can be identified by the intersection of the linear trend of eg towards uG with the ordinate 0.299, as done in FIG. 1. With this modality, a surface velocity of hydrogen of 0.144 fps (=4.38 cm/s) is obtained, a value not substantially different from the previous one. Such a method, therefore, allows to detect, in a simpler and in any case sufficiently precise way, the surface velocity uG\hat{ } of the hydrogen which, when fed to a given gas distributor, produces the packing of the bubbles.

Thus it is found that, by distributing gas (hydrogen) in a bubble column by means of gas distributors having an increasing number of orifices per m2 of horizontal section: 100, 400, 800, 1350 and more, the surface velocity uG\hat{ } of the gas (hydrogen) which produces the packing of the bubbles is continuously lowered. Each gas distributor will thus be characterized by a specific uG\hat{ } value depending on its orifice density.

If, in correspondence with the use of a gas distributor having a given orifice density, equal to 100 or greater, the gas (hydrogen) is fed with the surface velocity uG\hat{ } characteristic of the gas distributor used, the specific gas-liquid surface as\hat{ } will be raised without this having to raise the gas holdup above the bubble packing value 0.299.

The surface velocity of the gas (hydrogen) may be slightly higher, but in any case it will be such that the gas holdup does not exceed 0.33 to preserve the liquid filling of the reactor.

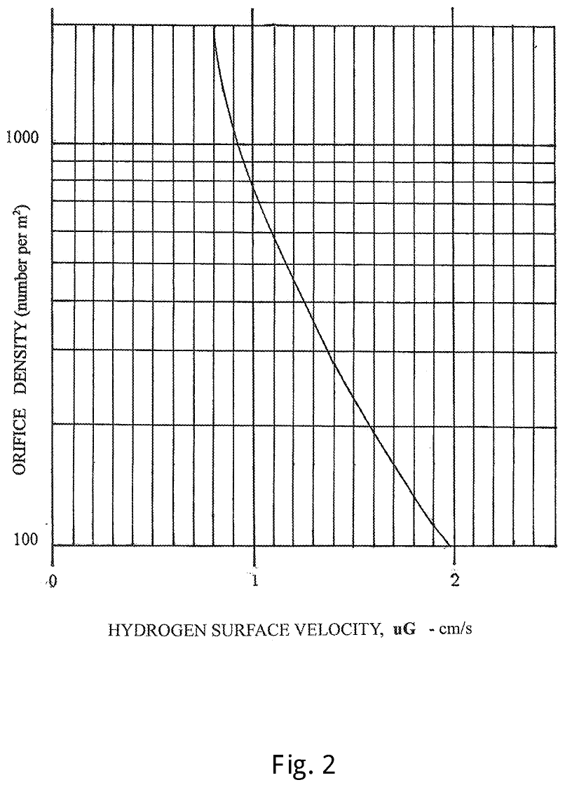

The hydrogenation capacity of a bubble column reactor with the use of dispersed catalysts (slurry bubble column reactor), which can be used, for example, in the hydroconversion of heavy oils or in the hydrotreatment of vacuum distillates, is increased by equipping an upflow reactor, at the its base, with a gas distributor having at least 100 orifices per m2, i.e. having an orifice density of at least 100, said gas distributor being immersed in the reaction liquid, placed from wall to wall of the reactor, and fed with hydrogen at a surface velocity limited to 2.5/(orifice density/50)⅓ cm/s, as a function of the density of the orifices of the same distributor used, as shown in graph in FIG. 2. The hydrogenation capacity is thus increased through the expansion of the specific gas-liquid surface without the gas holdup having to exceed the value of 0.33.

Preferably, the hydrogen is fed with a surface velocity not exceeding 2.08/(orifice density/50)⅓ cm/s, so as to operate with the highest liquid filling of the reactor while the gas-liquid unit surface is maximum. In this case the gas holdup will be 0.299 or close to this.

In the hydroconversion of heavy oils by conventional upflow reactors, which are characterized by the use of hydrogen distribution means with a low number of inputs per m2 (less than 64), gas holdup values close to 0.3 (see the aforementioned U.S. Pat. No. 5,308,476, column 5, row 1), in any case not higher than 0.33, are found. This means that, based on practical experience, a condition coinciding or close to the favorable bubble packing condition is constantly used; not necessarily consciously since the implication of the bubble packing phenomenon on a hydroconversion process does not appear to have been adequately considered previously.

The packing of the bubbles is, however, a condition that is not preserved if distribution means with a higher number of inlets or orifices are used to split the hydrogen flow while maintaining the flow rate, with which it is usually fed, unchanged. The rise in the gas holdup that results confirms this.

The present invention thus describes how to maintain the favorable bubble packing condition even when an upflow reactor, to expand the gas-liquid contact surface, is equipped with a gas distributor having a high density of orifices.

The process described in the present invention, always and in any case generating a liquid-gas bubbling mixture in bubble packing condition, optimizes the liquid filling of the reactor, as is currently done, but with bubbles whose diameter is reduced, through the choice of the density of orifices of the gas distributor, then through uG\hat{ }, as much as necessary to achieve the desired increase in hydrogenation capacity.

The measurement, at least in comparative terms, of the surface velocity uG\hat{ } of the gas at which, for a given gas distributor, the packing of the bubbles is completed, can be obtained, even out of reaction, in a column not necessarily under pressure, following the procedure described above.

A higher hydrogenation capacity will result in a more rapid decay of hydrogen partial pressure along the height of the reactor. The decay of the partial pressure can be compensated by inserting one or more distribution means along the height of the reactor to integrate hydrogen. However, as long as hydrogen is fed with a surface velocity indicatively not less than 1 cm/s, the lowering of the partial pressure can be compensated by an oversizing of the orifice density.

Gas distributors with a high number of orifices, indicatively over 300 per m2 of horizontal section, are preferably obtained by superimposing two or more grids with a limited number of orifices per m2, of simpler construction. For example, a gas distributor consisting of three overlapping grids, each of 270 orifices per m2, with a spacing between orifices of 6.08 cm, is approximately equivalent to a gas distributor consisting of a grid with 800 orifices per m2, which however has a orifice spacing restricted to 3.53 cm. A gas distributor consisting of five superimposed grids of 270 orifices per m2 each, for a total of 1350 orifices per m2, allows a specific gas-liquid surface three times that produced by a distributor having 100 orifices per m2.

The grids are superimposed at a distance not less than the horizontal spacing between orifices.

The use of multi-grid gas distributors is preferred to operate at the high orifice density necessary to obtain the highest expansion of the gas-liquid contact surface.

Even in the case of multi-grid gas distributors, the ability to lower the value of uG\hat{ } can be tested out of reaction, as mentioned above.

To obtain an expansion of the specific gas-liquid surface such as to lead to an appreciable increase in the unit capacity of a slurry reactor, used for the hydroconversion of heavy oils or for the hydrotreating of vacuum distillates, a gas distributor with at least 100 orifices per m2, as mentioned above, must be used. A minimum orifice density of 100 is required, due to the lack of gas holdup contribution on as\hat{ }. Gas distributors with a higher density of orifices will have to be used for a significant increases in the hydroconversion capacity and to bring the conversion of heavy oils totally to light hydrocarbons (350° C.−), as will be seen below.

### Slurry Hydroconversion of Heavy Oils Totally to Light Hydrocarbons (350° C.−)

In the slurry hydroconversion of a vacuum residue having a hydrogen content of 10.5%, a set of conversion products (product slate) is typically obtained whose average weight content of hydrogen rises to 14%. This corresponds to an incorporation of hydrogen in the products equal to 3.5% of the converted charge (percentage that rises to 4% including gases).

For a unit capacity of hydroconversion typically of about 0.1 t/h per m3 and an incorporation of hydrogen in the conversion products of 3.5%, a hydrogenation capacity of the slurry reactor of 0.0035 t/h per m3 results.

Reference is now made to a product slate comprising:
a light hydrocarbon fraction (350° C.−), consisting of LPG, naphtha, atmospheric gasoil;
a heavy fraction (350-540° C.), corresponding to a vacuum gasoil.

If the heavy fraction (350-540° C.), typically having a hydrogen content of 12.5%, were to be converted into the light fraction (350° C.−), which on average has a hydrogen content of 15.2%, the incorporation of hydrogen into the products would rise from 3.5 (14-10.5) % to 4.7 (15.2-10.5) %, increasing by 1.34 times. To achieve the necessary increase in hydrogenation capacity, the increase in the specific gas-liquid surface as\hat{ } is obtained by using a slurry reactor equipped with a gas distributor whose number of orifices per m2 has been selected for the purpose. Since the specific gas-liquid surface as generated by a gas distributor is directly proportional to 1/uG\hat{ }, the necessary orifice density to obtain the appropriate uG\hat{ } value is identified as specified below.

Compared with a gas distributor having 100 orifices per m2, fed with hydrogen at a surface velocity of 1.98 cm/s (see FIG. 2), a gas distributor with 256 orifices per m2, fed with hydrogen at a surface velocity of 1.45 cm/s, will generate a specific gas-liquid surface increased by (1/1.45):(1/1.98)=1.36 times.

Compared to a conventional slurry reactor operating with less than 64 orifices per m2, the increase in the specific gas-liquid surface resulting from the use of a slurry reactor equipped with a gas distributor having 256 orifices per m2 will be greater than 1.36 times, therefore certainly adequate to ensure the increase in hydrogenation capacity necessary to convert heavy oils totally to light hydrocarbons (350° C.−).

For product slates with hydrogen content further increased, for example to 16%, so as to bring the hydrogen content of atmospheric gas oil close to that of paraffinic hydrocarbons, the hydrogenation capacity of the slurry reactor will have to be increased in proportion of the greater quantity of hydrogen incorporated in the products, which will rise from 3.5 (=14-10.5) % to 5.5 (=16-10.5) % of the charge, that is, it will increase by 1.57 times. This will be achieved by further increasing the orifice density of the gas distributor. FIG. 2 shows how an increase in the orifice density, for example, from 100 to 800 per m2 leads to the halving of the hydrogen surface velocity, from 1.98 to 0.99 cm/s, with the consequent doubling of the specific gas-liquid surface. More than what is required for a 16% hydrogen content product slate.

The slurry upflow reactor described in the present application allows to reach suitable hydrogenation capacity not only to bring the hydroconversion of heavy oils totally to light hydrocarbons (350° C.−), but also to obtain product slates, with a high weight average content of hydrogen, which can be exploited as petrochemical feedstocks.

To converts heavy oils totally to light hydrocarbons (350° C.−), having a slurry bubble column reactor with the required hydrogenation capacity is the first but not the only necessary condition.

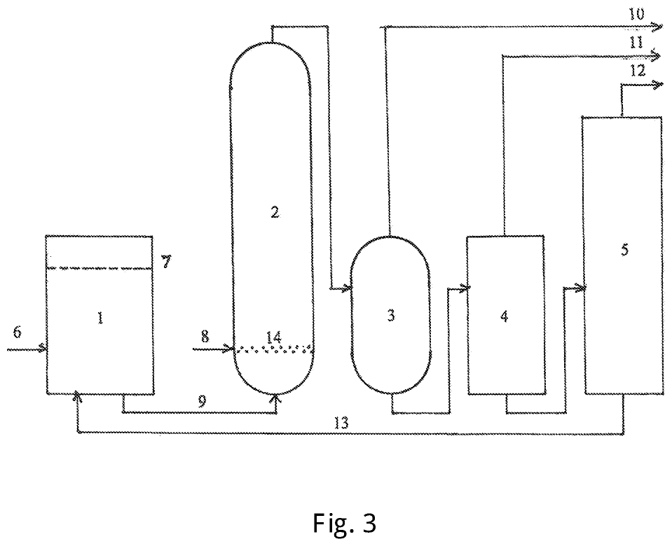

For the reasons that will follow, it is also necessary to operate according to a specific slurry hydroconversion process described below with the aid of FIG. 3. In FIG. 3, the upflow reactor is a bubble column that uses dispersed catalysts (slurry catalysts). The concentration of slurry catalyst is increased in proportion to the increase in the specific gas-liquid surface. The slurry catalyst includes one or more transition metals and is introduced into the reactor by means of an oil-soluble precursor. The gas distributor 14, which has a density of orifices that is chosen in relation to the quantity of hydrogen to be incorporated in the product slate, is fed with hydrogen whose surface velocity is limited, as a function of the density of orifices, to at least 2.5/(orifice density/50)⅓ cm/s, as already anticipated and shown in FIG. 2, and preferably limited to 2.08/(orifice density/50)⅓ cm/s.

The liquid-gas mixture leaving the reactor 2, at the head, is sent to the phase separator 3 which separates a gaseous phase 10 which contains the conversion products, in the vapor state and as gas, and unreacted hydrogen. The liquid phase at the bottom of 3 is sent to a depressurizer (flash tank) 4 at the head of which a further fraction of conversion product 11 is obtained. The liquid at the base of the depressurizer 4 is sent to a distillation column 5, operating at atmospheric pressure, to obtain the distillates 12. The bottom temperature of the column 5 can be lowered to raise the hydrogen content in the product slate.

The bottom of the atmospheric column 5, containing the slurry catalyst, usually sent to a distillation column operating under vacuum, in this case is recirculated to the reactor, after having been collected in the tank 1, where the feed to be converted is also fed.

What described in the present application is applicable to a crude oil, to an atmospheric residue, typically 350° C.+, to a vacuum distillation residue, typically 540° C.+, and also to a heavy distillates 350° C.+, such as a vacuum distillate, and to hydrocarbon mixture containing them. If the charge consists of crude oil, the feeding takes place to the atmospheric column 5, so that the liquid of thank 1 is in any case free of light hydrocarbons (350° C.−).

The fraction 350-540° C., usually extracted in a column under vacuum, in the present invention goes back into reaction where it will be converted to light hydrocarbons (350° C.−).

The increase in the concentration of light hydrocarbons (350° C.−), which follows the conversion of the 350-540° C. fraction, makes the reaction liquid unstable due to the separation of asphaltenes.

By feeding the atmospheric bottom 13 directly to the reactor, after a short time, a pronounced non-uniformity appears in the axial temperature profile of the reactor. This is a consequence of the separation, at the bottom of the reactor, of a high viscosity-high density asphaltene phase which, causing a malfunction of the gas distributor, makes hydroconversion unworkable.

To manage the concentration of light hydrocarbons (350° C.−) in the reaction liquid, so that this can regress as much as necessary, the atmospheric residue 13 and the charge 6 are both collected in the same tank 1 to form a mixture (350° C.+), free of light hydrocarbons (350° C.−), which is fed to the reactor through line 9 with a flow rate equal to twice that of the feed charged, occurring with a flow rate greater than twice, so as to approximately halve, and more than halve, the concentration of light hydrocarbons (350° C.−) in the reaction liquid.

Since the one described is a closed loop recirculating system, the flow rate of charge fed is that which maintains a constant level 7 in tank 1.

Feeding the mixture of atmospheric residue and charge in this way, the light hydrocarbons (350° C.−) are removed from the reaction liquid faster, which will allow the reactor to return to its original condition. The recovery of the uniformity of the axial temperature will confirm the restoration of the reactor functionality.

On the basis of the description provided for an exemplary embodiment, it is obvious that some changes can be introduced by the person skilled in the art without thereby departing from the scope of the invention as defined by the following claims.

1. Process for the hydroconversion of heavy oils, including crude oils, and for the hydrotreatment of vacuum distillates, by means of an upflow bubble column reactor using a slurry-type catalyst,
said reactor having inside gas distribution means, said distribution means:
being fed with hydrogen, or gas including hydrogen,
being housed in a lower portion of said reactor so as to be immersed in the reaction liquid, and
comprising a plurality of orifices which inject hydrogen, or gas including hydrogen, into said reaction liquid,
said orifices being present in number of at least 100 per m² of horizontal section of said distribution means,
said number of orifices per m2 of horizontal section of distribution means being called “orifice density”,
said process including:
an extraction of conversion products in a distillation section downstream the reactor, and
a recycling to said reactor of residue of said distillation section,
wherein hydrogen, or gas including hydrogen, is fed to said distribution means at a surface velocity, expressed in cm/s, not exceeding
2.5/(orifice density/50)^{1/3},
being the ratio (orifice density/50) dimensionless.

2. The process according to claim 1, wherein hydrogen, or gas including hydrogen, is fed to said distribution means at a surface velocity, expressed in cm/s, not exceeding
2.08/(orifice density/50)^{1/3},
being the ratio (orifice density/50) dimensionless.

3. The process according claim 1, further comprising:
feeding the charge to be converted into a tank,
sending said residue to said tank, so as to form a mixture comprising said charge and said residue, and
feeding said mixture into said reactor with a flow rate at least equal to twice that with which said charge is fed into said tank,
said charge being fed into said tank with a flow rate such as to keep constant the level of said mixture in said tank.

4. The process according claim 2, further comprising:
feeding the charge to be converted into a tank,
sending said residue to said tank, so as to form a mixture comprising said charge and said residue, and
feeding said mixture into said reactor with a flow rate at least equal to twice that with which said charge is fed into said tank,
said charge being fed into said tank with a flow rate such as to keep constant the level of said mixture in said tank.
